(19) United States
(12) Patent Application Publication
(10) Pub. No.: US 2008/0155325 A1
(43) Pub. Date: Jun. 26, 2008

(54) APPARATUS, SYSTEM, AND METHOD FOR PROVIDING A MULTI-DIMENSIONAL WEIGHTED PROPAGATED STATUS

(76) Inventors: Thomas Rudolf Anzelde, San Jose, CA (US); Zhao Lu, Campbell, CA (US); Bogdan Macarie, Bucharest (RO); Roberto C. Pineiro, Mayaguez, PR (US); Christopher Jacob Rich, Tigard, OR (US); Chung-Hao Tan, San Jose, CA (US)

Correspondence Address: Kunzler & McKenzie, 8 EAST BROADWAY, SUITE 600, SALT LAKE CITY, UT, 84111, US

(21) Appl. No.: 11/613,855

(22) Filed: Dec. 20, 2006

(51) Int. Cl. G06F 11/30

(52) U.S. Cl. 714/25

(57) ABSTRACT

An apparatus, system, and method are disclosed for providing a multi-dimensional weighted propagated status. The multi-dimensional weighted propagated status is provided by establishing a system including one or more system entities; establishing at least two status values for representing a condition of the system entities; assigning a status weight to each of the status values; assigning one of the status values to each of the system entities; and determining a propagated status for the system based on the status values assigned to the system entities, the status weights assigned to the status values, and the entity weights assigned to the system entities.

### BACKGROUND OF THE INVENTION

1. Field of the Invention

This invention relates to monitoring the overall health of a system and more particularly relates to determining a weighted propagated status from the status of the various components of a system.

2. Description of the Related Art

As the complexity of electronic and mechanical systems grows, so does the need for easier ways to manage the entities that make up such systems. In particular, it is useful to be able determine the overall health of a system without having to check the condition of each entity individually. In conventional art, a status value may be assigned to the individual entities of a system to represent the health, performance, and operational status of each entity. Thus, a user can quickly determine the current functionality of each entity individually.

Conventional art has also made it possible to represent the status of a group of individual entities as a single status value representing the functionality of the group as a whole. Such a representation is called a propagated status. For example, in one embodiment of the conventional art, each entity within a system may be assigned one of four statuses: 1) normal—the entity is operating normally, 2) warning—some or parts of the entity are not operating or have serious problems, 3) critical—the entity is either not operating or has serious problems, and 4) unknown—the health of the entity is unknown. Then, rules may be created such that a particular combination of status values result in a propagated status that represents the health of the system as a whole. For example, in one embodiment, the propagated status may be determined as follows: 1) normal—when all entities are of normal status, 2) warning—when there is at least one entity with normal status, 3) critical—when all entities are either critical or warning, and 4) unavailable when all entities have unavailable status.

The problem with conventional methods for determining propagated status is that they do not provide enough granularity to give a precise representation of the health of the system as a whole. For example, if the propagated status of a system is at the warning level, meaning that at least one entity is still operating with a normal status, then regardless of the number of entities that change from a normal status to a warning or critical status, the propagated status of the system will remain unchanged until every single entity has been assigned a non-normal status. Thus, it is quite common for entities within the system to change status, but for that entity status change to not be reflected in the propagated status of the system. By introducing weight to status, this type of problem can be overcome.

Furthermore, conventional methods for determining propagated status do not allow users to assign weight to the entities within a system. Thus, less vital entities have the same effect on the calculation of the propagated status as do the most vital entities within the system. By assigning weights to each of the entities within a system to reflect their importance, the overall status of the system can be more accurately represented.

From the foregoing discussion, it should be apparent that a need exists for an apparatus, system, and method that provide a multi-dimensional weighted propagated status for a system. Beneficially, such an apparatus, system, and method would reflect the overall status of a system more accurately and at a higher granularity level than is currently available in the prior art.

### SUMMARY OF THE INVENTION

The present invention has been developed in response to the present state of the art, and in particular, in response to the problems and needs in the art that have not yet been fully solved by currently available methods for determining propagated status. Accordingly, the present invention has been developed to provide an apparatus, system, and method for providing a multi-dimensional weighted propagated status that overcome many or all of the above-discussed shortcomings in the art.

An apparatus to provide a multi-dimensional weighted propagated status is provided with a logic unit containing a plurality of modules configured to functionally execute the necessary steps of establishing a system comprising one or more system entities; establishing at least two status values for representing a condition of the one or more system entities; assigning a status weight to each of the at least two status values; assigning an entity weight to each of the one or more system entities; assigning one of the at least two status values to each of the one or more system entities; and determining a propagated status for the system based on the status values assigned to the one or more system entities, the status weights assigned to the at least two status values, and the entity weights assigned to the one or more system entities such that the propagated status reflects the overall condition of the system.

In one embodiment of the apparatus, each of the one or more system entities includes one or more sub-entities. The apparatus may then assign a sub-entity weight to each of the one or more sub-entities such that the entity weight comprises an aggregation of the sub-entity weights. In a further embodiment, the status weight and the entity weight may be defined by a user. In yet another embodiment, one of the at least two status values is assigned to each of the one or more system entities based on a current condition of the system entity, and one of the at least two status values may be further assigned to one of the one or more system entities in response to a change in the current condition of the system entity. In another embodiment, the propagated status is presented to a user.

A system of the present invention is also presented to provide a multi-dimensional weighted propagated status. The system, in one embodiment, includes one or more system entities and a propagated status determination tool. The propagated status determination tool, in one embodiment, is comprised of a status definition module configured to establish at least two status values for representing a condition of the one or more system entities; a status weight module configured to assign a status weight to each of the at least two status values; an entity weight module configured to assign an entity weight to each of the one or more system entities; a status assignment module configured to assign one of the at least two status values to each of the one or more system entities based on a current condition of the system entity; a propagated status module configured to determine a propagated status for the system based on the status values assigned to the one or more system entities, the status weights assigned to the at least two status values, and the entity weights assigned to the one or more system entities such that the propagated status reflects the overall condition of the system; and a presentation module for presenting the propagated status to a user.

In one embodiment of the system, each of the one or more system entities is comprised of one or more sub-entities, and the entity weight module is further configured to assign a sub-entity weight to each of the one or more sub-entities such that the entity weight comprises an aggregation of the sub-entity weights. In another embodiment, the system may include one or more system tasks, and the entity weight module may be further configured to assign a task weight to each of the one or more system tasks. In a further embodiment, the status assignment module may be configured to assign one of the at least two status values to each of the one or more system tasks based on a current condition of the system task such that the at least two status values further represent a condition of the one or more system tasks. In yet a further embodiment, the propagated status module is further configured to determine a propagated status based on the status values assigned to the one or more system tasks and the task weights assigned to the one or more system tasks.

A method of the present invention is also presented for providing a multi-dimensional weighted propagated status. The method in the disclosed embodiments substantially includes the steps necessary to carry out the functions presented above with respect to the operation of the described apparatus and system. In one embodiment, the method includes determining a propagated status for a system based on the weighted status values and the corresponding weighted system entities and weighted system tasks such that the propagated status reflects the overall condition of the system.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for providing a multi-dimensional weighted propagated status in accordance with the present invention;

FIG. 2 is a schematic block diagram illustrating one embodiment of a system entity in accordance with the present invention; and

FIG. 3 is a schematic flow chart diagram illustrating one embodiment of a method for providing a multi-dimensional weighted propagated status in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer program product may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

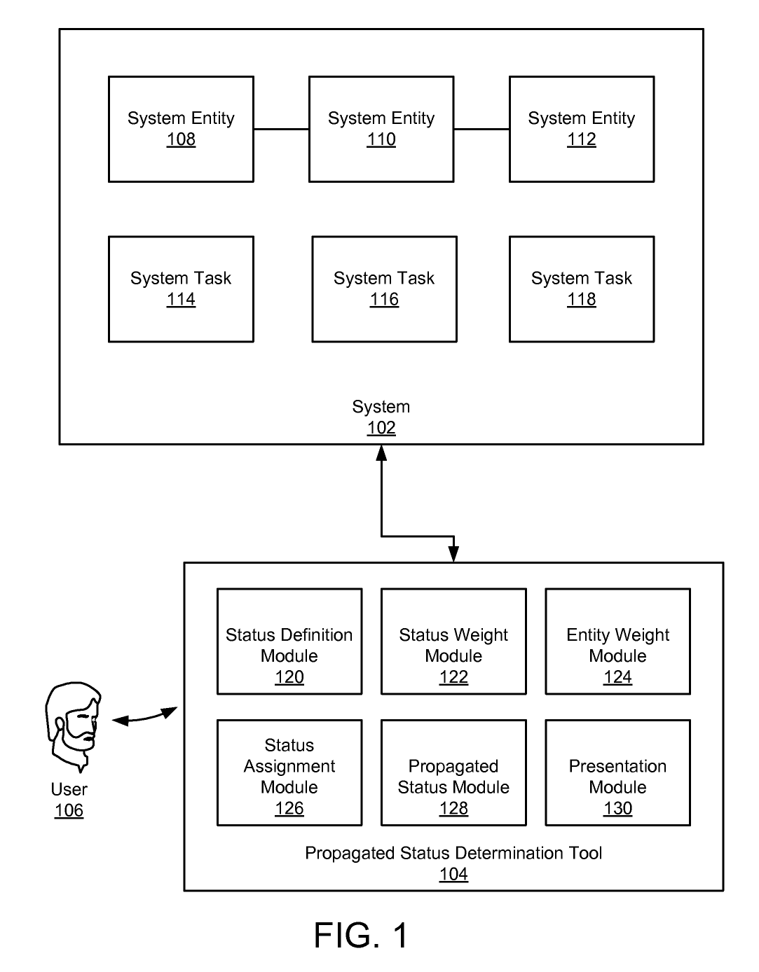

FIG. 1 depicts one embodiment of the present invention for providing a multi-dimensional weighted propagated status. Included are a system 102, a propagated status determination tool 104, and a user 106.

The system 102, in one embodiment, may be an electronic system such as a computer system or network, or in other embodiments, may be a mechanical or electro-mechanical system such as an assembly line or a manufacturing machine. The system 102 includes the system entities 108, 110, 112. In one embodiment, the system entities 108, 110, 112 are the various components that make up the system 102. For example, if the system 102 is an assembly line, then the system entity 108 might represent a welding machine and the system entity 110 might represent a painting machine. In another embodiment, if the system 102 is a computer network, then the system entity 108 might be a port, and the system entity 110 might be a switch.

The system 102, in one embodiment, includes system tasks 114, 116, 118. The system tasks 114, 116, 118 are typically the processes or operations that are carried out by the system 102. For example, if the system 102 is an assembly line, then one system task 114 might include a sequence of welding operations to create a structure, and another system task 116 might include a series of painting operations to paint the structure. If the system 102 is a computer system, then a system task 114 might include running a program or application.

The propagated status determination tool 104, in one embodiment, includes a status definition module 120, a status weight module 122, an entity weight module 124, a status assignment module 126, a propagated status module 128, and a presentation module 130.

The status definition module 120 is configured to establish at least two status values for representing a condition of the system entities 108, 110, 112 or the system tasks 114, 116, 118. In various embodiments, the status values may indicate the health, performance, or policy compliance of the system entities 108, 110, 112 or the system tasks 114, 116, 118. For example, the status values may include values such as normal, warning, critical, or unavailable for reflecting the actual condition of the system entities 108, 110, 112 or the system tasks 114, 116, 118. In another example, more granularity might be needed so the status values might also include values such as somewhat critical or very critical. In another embodiment, the status values may be numerical. For example, a lower number might indicate a healthier status than a higher number.

The status weight module 122 is configured to assign a status weight to each of the status values established by the status definition module 120. For example, if the status values are normal, warning, and critical, then each of these values is assigned a weight. In one embodiment, the weight might be a percentage wherein a normal status might be assigned a weight of 0, a warning status might be assigned a weight of 0.33, and a critical status might be assigned a weight of 0.67. Thus, a status value of critical would reflect more heavily on the overall health of the system 102 than would a status value of warning. In another embodiment, the status weight may be a number or other value that has meaning relative to the values of each of the other status weights. For example, normal might be assigned a weight of ten, warning might be assigned a weight of 20 and, critical might be assigned a weight of 30. Once again, a status value of critical reflects more heavily on the overall health of the system 102 than does the warning or normal values. The status weights may be assigned automatically in one embodiment or may be assigned by a user 106 in another embodiment.

The entity weight module 124 is configured to assign an entity weight to each of the system entities 108, 110, 112. The entity weight may be a percentage value in one embodiment. In another embodiment, the entity weight may be a number or other value that has meaning relative to the value of each of the other entity weights similar to the status weights described above. For example, a system entity 108, in one embodiment, might be deemed more important to the system 102, than another system entity 110. Thus, a weight may be assigned to the system entity 108 that is higher in value compared to the weight assigned to the other system entities 110, 112. For example, if the system 102 is a computer system, then the system's sound card might be less important to the overall status of the system 102 than the video card. Thus, a larger entity weight might be assigned to the video card than to the sound card. In one embodiment, one or more of the system entities 108, 110, 112 may be assigned a weight of zero such that the entity's condition is not reflected at all in the overall status of the system. Furthermore, the entity weights may be assigned automatically in one embodiment or may be assigned by a user 106 in another embodiment.

In one embodiment, the entity weight module 124 is further configured to assign a task weight to each of the system tasks 114, 116, 118. The task weights operate in the same manner as the entity weights described above, except they are assigned to system tasks 114, 116, 118 instead system entities 108, 110, 112. By assigning the more important tasks a higher weight, the overall status of the system can be more accurately depicted. Like the entity weights, the task weights may be assigned automatically in one embodiment or may be assigned by a user 106 in another embodiment.

The status assignment module 126 is configured to assign one of the status values to each of the system entities 108,110,112 and each of the system tasks 114,116,118 based on the current condition of the system entity 108, 110, 112 or system task 108, 110, 112. For example, if system entity 108 is performing without any problems, it may be assigned a status value of normal. If system entity 110 is experiencing several problems it may be assigned a status value of warning or critical. In one embodiment, a new status value is assigned to the system entity 108 in response to a change in the condition of the system entity 108. For example, if the system entity 108 is operating without any problems such that it is assigned a status value of normal, then when the system entity 108 begins experiencing problems, a new status value of warning or critical may be assigned to the system entity 108.

The propagated status module 128 is configured to determine a propagated status for the system based on the status values assigned to the system entities 108, 110, 112, the status weights assigned to the status values 114, 116, 118, the entity weights assigned to system entities 108, 110, 112 and the task weights assigned to the system tasks 114, 116, 118 such that the propagated status reflects the overall condition of the system 102. By determining a propagated status based on the weighted status values and the corresponding weighted system entities 108, 110, 112 and weighted system tasks 114, 116, 118, the propagated status is able to provide an indication of the overall health and performance of the system 102 with high granularity and accuracy. Furthermore, by assigning weight to the status values as well as the system entities 108, 110, 112 and the system tasks 114, 116, 118, the propagated status determination tool 104 is able to provide a multi-dimensional weighted propagated status.

For example, if the system 102 is an assembly line that includes a welding machine and a painting machine as system entities 108, 110, 112, then the welding machine might be assigned an entity weight of 0.75 and the painting machine might be assigned an entity weight of 0.25. Furthermore, status values of critical, warning, and normal might each be assigned a status weight such that a critical status is given a weight of 0.67, a warning status is given a weight of 0.33, and a normal status is given a weight of 0. In accordance with the present invention, a status value is assigned to each of the welding machine and the painting machine to reflect the current condition of those system entities 108, 110, 112. Thus, the welding machine might be assigned a critical status and the painting machine might be assigned a warning status. In one embodiment, the propagated status for this system 102 may be calculated using the formula: (Σ(Wi*Si))/ΣWi, where Wi is the entity weight or task weight and Si is the status weight. Therefore, the equation yields ((0.75*0.67)+(0.25*0.33))/(0.75+0.25)=0.59 as the propagated status. This value, in one embodiment, may also be translated back into a status value such as warning, or for more granularity, a value such as high warning or very high warning. It will be recognized by one of skill in the art that there are numerous other methods for calculating weighted values such that the result reflects the relative importance of various system entities 108, 110, 112.

In a further example, suppose the welding machine has been repaired such that it has been assigned a normal status instead of a critical status. The result then becomes ((0.75*0)+(0.25*0.33))/(0.75+0.25)=0.08. The value of the propagated status (.08) reflects a large change in the overall health of the system (compared to 0.59) because of the large entity weight (0.75) assigned to the welding machine and the large status weight (0.67) assigned to the critical status. Thus, the more heavily weighted system entities 108, 110, 112 or system tasks 114, 116, 118 have a greater effect on the propagated status.

The presentation module 130 is configured to present the propagated status to a user 106. In one embodiment, the propagated status is presented to the user 106 on a graphical display such that the user 106 can monitor the status of the system 102 in real time or see a history of the propagated status. In another embodiment, the propagated status may be presented in text such as in a report or in a file. It will be recognized by one of skill in the art that the propagated status may be presented to the user 106 in numerous other ways such as via the internet or in audible form via a speaker.

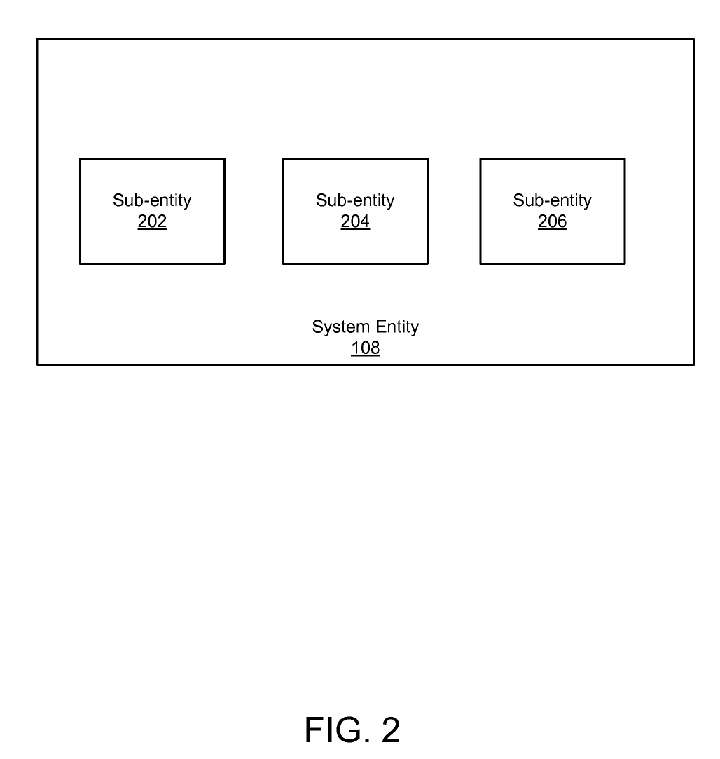

FIG. 2 depicts one embodiment of a system entity 108 that is comprised of sub-entities 202, 204, 206. In one embodiment, each sub-entity 202, 204, 206 is assigned a sub-entity weight by the entity weight module 124 such that the entity weight corresponding to system entity 108 is an aggregation of the sub-entity weights. Thus, if sub-entity 202 is assigned a sub-entity weight of 0.02, sub-entity 204 is assigned a sub-entity weight of 0.21, and sub-entity 206 is assigned a sub-entity weight of 0.09, the entity weight of system entity 108 would be 0.32. For example, if the system 102 is a computer network and a personal computer is a system entity 108 within the system 102, then a hard-disk drive (HDD) within the personal computer might be a sub-entity 202 of the personal computer system 102. The sub-entity weights may also be assigned automatically in one embodiment or may be assigned by a user 106 in another embodiment.

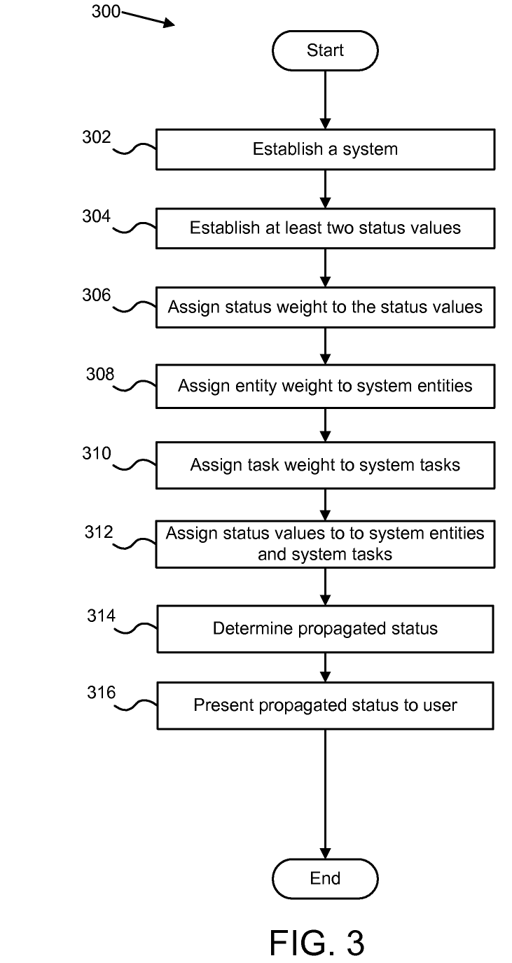

FIG. 3 depicts one embodiment of a method 300 for providing a multi-dimensional weighted propagated status in accordance with the present invention. The method 300 substantially includes the steps and modules described above with regard to FIGS. 1 and 2. The method 300 begins by establishing 302 a system 102 that includes system entities 108, 110, 112 and system tasks 114, 116, 118. The system 102, in one embodiment, may be a sub-system of a larger system or, in another embodiment may be larger system composed of numerous sub-systems. The status definition module 120 establishes 304 at least two status values for representing a condition of the system entities 108, 110, 112 and the system tasks 114, 116, 118. The status weight module 122 assigns 306 a status weight to each of the status values. The status weights, in one embodiment, are defined by a user 106.

Then, the entity weight module 124 assigns 308 an entity weight to each of the system entities 108, 110, 112 and assigns 310 a task weight to each of the system tasks 114, 116, 118. In one embodiment, the entity weights and task weights are defined by a user. The status assignment module 126 assigns 312 one of the status values to each of the system entities 108, 110, 112 and each of the system tasks 114, 116, 118 based on a current condition of the system entity 108, 110, 112 or system task 114, 116, 118. The propagated status module 128 determines 314 a propagated status for the system based on the weighted status values and the corresponding weighted system entities 108, 110, 112 and weighted system tasks 114, 116, 118 such that the propagated status reflects the overall condition of the system 102. The presentation module 130 presents 316 the propagated status to a user 106. The method 300 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having: computer usable program code programmed for providing a multi-dimensional weighted propagated status, the operations of the computer program product comprising:
establishing a system comprising one or more system entities;
establishing at least two status values for representing a condition of the one or more system entities;
assigning a status weight to each of the at least two status values;
assigning an entity weight to each of the one or more system entities;
assigning one of the at least two status values to each of the one or more system entities; and
determining a propagated status for the system based on the status values assigned to the one or more system entities, the status weights assigned to the at least two status values, and the entity weights assigned to the one or more system entities.

2. The computer program product of claim 1, wherein each of the one or more system entities is comprised of one or more sub-entities.

3. The computer program product of claim 2, the operations further comprising assigning a sub-entity weight to each of the one or more sub-entities such that the entity weight comprises an aggregation of the sub-entity weights.

4. The computer program product of claim 1, wherein the status weight is defined by a user.

5. The computer program product of claim 1, wherein the entity weight is defined by a user.

6. The computer program product of claim 1, wherein one of the at least two status values is assigned to each of the one or more system entities based on a current condition of the system entity.

7. The computer program product of claim 6, the operations further comprising assigning one of the at least two status values to one of the one or more system entities in response to a change in the current condition of the system entity.

8. The computer program product of claim 1, the operations further comprising presenting the propagated status to a user.

9. A system to provide a multi-dimensional weighted propagated status, the system comprising:
one or more system entities;
a propagated status determination tool comprising:
a status definition module configured to establish at least two status values for representing a condition of the one or more system entities;
a status weight module configured to assign a status weight to each of the at least two status values;
an entity weight module configured to assign an entity weight to each of the one or more system entities;
a status assignment module configured to assign one of the at least two status values to each of the one or more system entities based on a current condition of the system entity; and
a propagated status module configured to determine a propagated status for the system based on the status values assigned to the one or more system entities, the status weights assigned to the at least two status values, and the entity weights assigned to the one or more system entities such that the propagated status reflects the overall condition of the system.

10. The system of claim 9, wherein each of the one or more system entities is comprised of one or more sub-entities.

11. The system of claim 10, wherein the entity weight module is further configured to assign a sub-entity weight to each of the one or more sub-entities such that the entity weight comprises an aggregation of the sub-entity weights.

12. The system of claim 9, further comprising one or more system tasks.

13. The system of claim 12, wherein the entity weight module is further configured to assign a task weight to each of the one or more system tasks.

14. The system of claim 13, wherein the status assignment module is further configured to assign one of the at least two status values to each of the one or more system tasks based on a current condition of the system task and wherein the at least two status values further represent a condition of the one or more system tasks.

15. The system of claim 14, wherein the propagated status module is further configured to determine a propagated status based on the status values assigned to the one or more system tasks and the task weights assigned to the one or more system tasks.

16. A method for providing a multi-dimensional weighted propagated status, the method comprising:
establishing a system comprising one or more system entities;
establishing at least two status values for representing a condition of the one or more system entities;
assigning a user-defined status weight to each of the at least two status values;
assigning a user-defined entity weight to each of the one or more system entities;
assigning one of the at least two status values to each of the one or more system entities based on a current condition of the system entity; and
determining a propagated status for the system based on the weighted status values and the corresponding weighted system entities such that the propagated status reflects the overall condition of the system.

17. The method of claim 16, wherein the system further comprises one or more system tasks.

18. The method of claim 17, further comprising assigning a task weight to each of the one or more system tasks.

19. The method of claim 18, further comprising assigning one of the at least two status values to each of the one or more system tasks based on a current condition of the system task and wherein the at least two status values further represent a condition of the one or more system tasks.

20. The method of claim 19, wherein determining a propagated status is further based on the weighted system tasks.
